(19) United States
(12) Patent Application Publication
(10) Pub. No.: US 2010/0058708 A1
(43) Pub. Date: Mar. 11, 2010

(54) METHOD FOR EXTENDING A MOUNTING WORKSHOP IN AN AUTOMOBILE MANUFACTURING PLANT AND RELATED MOUNTING WORKSHOPS

(75) Inventors: Vincent Tondini, Guyancourt (FR); Celine Deloget, Versailles (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/530,054

(22) PCT Filed: Feb. 4, 2008
(86) PCT No.: PCT/FR08/50176

§ 371 Date: Sep. 4, 2009

(30) Foreign Application Priority Data
Mar. 7, 2007 (FR) 0753705

(51) Int. Cl. E04H 5/02; B23P 21/00

(52) U.S. Cl. 52/741.1; 29/705

(57) ABSTRACT

The invention relates to a method for extending a assembly shop in an automobile manufacturing plant in order to increase the vehicle production rate and in order to obtain a new assembly shop from a former assembly shop that is older by several years, wherein the former assembly shop includes an assembly line including a body trim portion and a vehicle assembly portion, the body trim portion including one or more existing body trim sections (1), the vehicle assembly portion including one or more vehicle assembly sections (2), wherein: several sections are added to said existing sections, the location of which at least is preserved; the added sections are not arranged as an extension of the preserved existing section(s) nor as an extension of the preserved location(s) of existing sections; and the location of the former workshop is preserved.

The invention relates to the field of methods for expanding an assembly shop of a motor vehicle manufacturing plant, as well as the field of assembly shops in motor vehicle manufacturing plants that exist pre-expansion, as they are obtained post-expansion. The motor vehicles in question are preferably passenger cars or light utility vehicles. The production rate figures given herein are for passenger vehicles or light utility vehicles, but not trucks, for example.

In an assembly shop of a motor vehicle manufacturing plant, one attempts to reach the best possible compromise between various constraints. The quality of the vehicles manufactured and the ergonomics of assembly shop operations are to be maximized as much as possible, relative to an industrial investment, which one tries to minimize as much as possible. This assembly shop must do its best to accommodate the diversity of vehicles to be manufactured, if not in all vehicle segments, then at least within one vehicle segment. The standardized designation for a vehicle category is the term “segment”. In the sense of the standardized designation, the various “segments” or “vehicle segments” are M1, M2, B1, B2, and H. Over time, the variation in needed vehicle production volume can be significant, and this provides an incentive to try and make the shop upgradable, while pushing down the cost of transitioning from one upgrade stage to another. This is especially true in countries with emerging markets, where the desired vehicle production rate may be initially low, and then increase to end up becoming significant, reaching the level that this production might have in countries with developed markets. An assembly shop that can be expanded relatively easily over time and at a reasonable cost is an upgradable assembly shop.

An assembly shop is upgradable as opposed to conventional assembly shops, where increases in the production rate either result in assembly shops that are not optimized in terms of output or necessitate practically leveling the existing shop and building over again from scratch in order to be able to optimize output. Conventional assembly shops have been built for a given production rate or for a given range of production rates, and were not designed from the outset to shift to higher production rates with output still optimized.

According to a prior art for an upgradable shop, described for example in French patent application FR 2638196 and American application US 20020129566, a way is known to build a workshop—and even a plant—made up of modular elements. Having these modular elements makes the workshop highly upgradable, and this is the case somewhat regardless of the initial arrangement. However, no matter what the upgrade stage, whether at the outset or in process, these modular elements do not allow for much flexibility in the initial arrangement of the shop and the plant, nor for optimized output. That is, a significant constraint hinders this type of upgradable workshop and plant, i.e., the necessity of reducing the various production lines, and the various logistical and secondary operations areas, to a combination of one or more modular elements with an identical, or at least similar, fixed structure.

The invention proposes a radically different approach. Upgradability will be relatively easy to provide, not because the shop would be made of identical or similar basic building blocks arranged in some initial order to which other basic building blocks are easily added, but rather because the initial arrangement of the shop, i.e., the initial configuration of its various parts, is designed in a particular way that allows for relatively easy upgradability, even if part or all of the initial shop is of masonry construction. The invention is still usable with a shop made of prefabricated modular elements, but clearly has less relevance. In each upgrade stage, the compromise that is made between increasing the production rate on the one hand and minimizing investment and resulting disturbances within the shop on the other incorporates the compromises pertaining to the other planned upgrade stages. It is preferable to aim for quick adaptability while keeping investments virtually linear in the transition from one upgrade stage to another.

This is a matter of determining what initial configuration of the plant will cause the least possible disruption when the production rate increases, and not be too expensive initially, although this initial configuration may cost more than one that would be optimal for a low-production assembly shop, but would be practically impossible to upgrade under reasonable economic conditions.

The invention proposes a method for expanding an assembly shop in order to increase the vehicle production rate. This expansion method will be applied with particular efficiency when the assembly shop to which this method is applied has a suitable configuration. Consequently, the invention also proposes the corresponding installed assembly shops before expansion. The assembly shops obtained after expansion are also within the scope of the invention.

According to the invention, a method is provided for expanding an assembly shop of a motor vehicle manufacturing plant in order to increase the vehicle production rate, so as to obtain a new assembly shop from an assembly shop some years older, wherein said assembly shop comprises an assembly line comprising a body trim part and a vehicle assembly part, the body trim part comprises one or more existing body trim sections, and the vehicle assembly part comprises one or more existing vehicle assembly sections, characterized in that: a plurality of sections are added to said existing sections, whose locations at least are retained; said added sections are not placed in line with said retained existing section or sections nor with said retained location or locations of existing sections; the location of the previous workshop is retained.

According to the invention, provision is also made for an assembly shop of a motor vehicle manufacturing plant, comprising: at least one assembly line comprising a body trim part followed by a vehicle assembly part, characterized in that: the body trim part comprises a body trim section, the vehicle assembly part comprises a vehicle assembly section, with said body trim section and said vehicle assembly section located across from one another.

According to the invention, provision is also made for an assembly shop of a motor vehicle manufacturing plant, comprising: at least one assembly line comprising a body trim part followed by a vehicle assembly part, characterized in that: the body trim part comprises two body trim sections that are across from one another, the vehicle assembly part comprises two vehicle assembly sections that are across from one another, and said vehicle assembly sections are orthogonal to said body trim sections.

According to the invention, provision is also made for an assembly shop of a motor vehicle manufacturing plant, comprising: at least one assembly line comprising a body trim part followed by a vehicle assembly part, characterized in that: the body trim part comprises four body trim sections that are aligned next to each other, the vehicle assembly part comprises four vehicle assembly sections that are aligned next to each other, and said vehicle assembly sections are orthogonal to said body trim sections.

The invention will now be described in greater detail using the annexed figures, which are given as illustrative and non-limiting examples, in which:

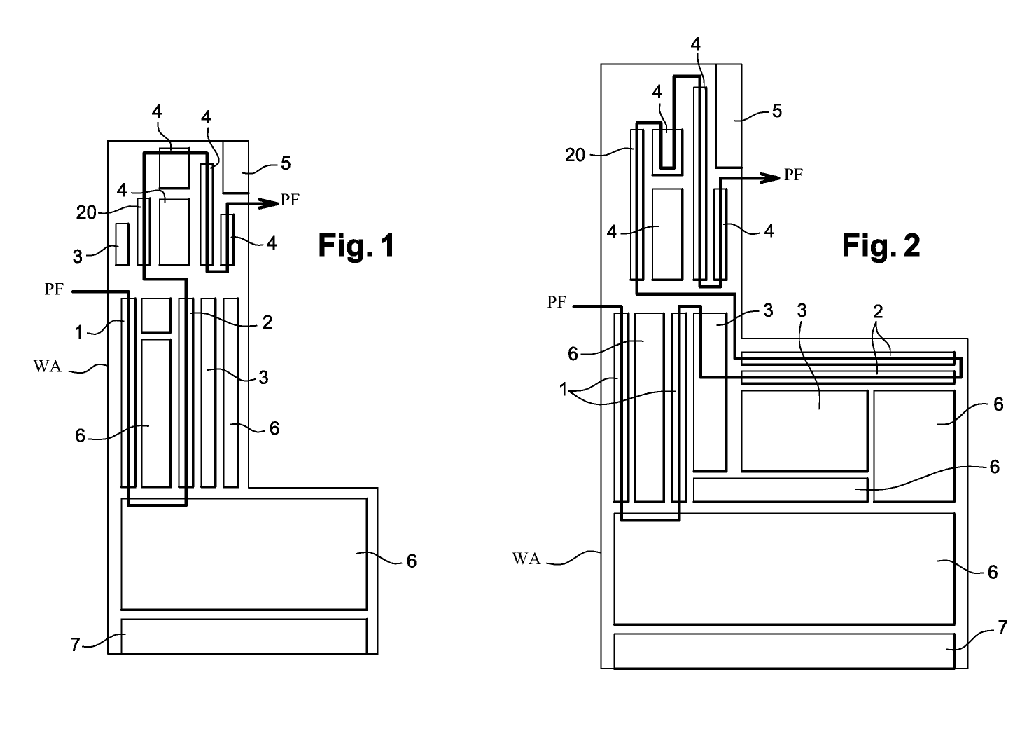

FIG. 1 schematically shows an example of an assembly shop of a low-output motor vehicle manufacturing plant according to the invention;

FIG. 2 schematically shows an example of an assembly shop of a medium-output motor vehicle manufacturing plant according to the invention;

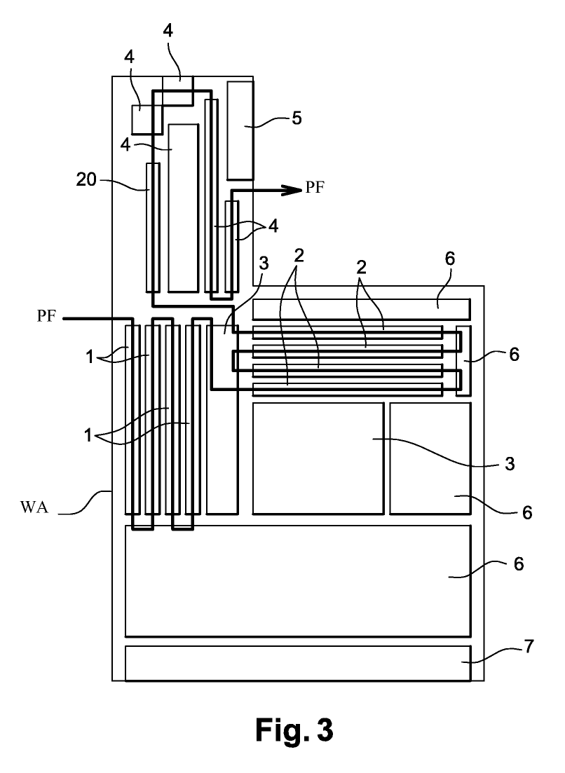

FIG. 3 schematically shows an example of an assembly shop of a high-output motor vehicle manufacturing plant according to the invention.

A plant is built on a site. This site is enclosed; it is surrounded by a fence. The fence comprises temporary or permanent openings that allow the various entering and exiting plant traffic to flow.

Preferably, in the central part of the site there are built areas, in the form of multiple separate buildings or in the form of a common building, for housing support functions. These built areas for support functions relate to certain common facilities, such as administrative offices that provide administrative support for the workshops around them.

The built areas are surrounded by various workshops extending from the central part of the site, where the built areas are grouped together, toward the periphery of the site in the direction of the fence. These workshops include at least a body welding shop, a paint shop, and an assembly shop. In the body welding shop, the vehicle bodies are assembled, typically from pre-stamped sheet metal panels. In the paint shop, the vehicle bodies are painted. In the assembly shop, the painted vehicle bodies are outfitted to become complete, drivable vehicles. The assembly shop includes a) the production line or lines and b) the logistical support associated with assembly as well as the corresponding secondary operations areas. Logistical support includes in particular the parts and subassemblies that will be supplied to the production line.

An additional area, corresponding to the roll-test area, i.e., the last stage of production following assembly and comprising the steps of testing and adjusting the newly manufactured vehicles, can either be preferably integrated into the assembly shop or be contiguous with the assembly shop, but then in this latter case, the roll-test area is separated from the assembly shop by at least a wall, for example.

Other elements are also located on the plant site, such as a vehicle touch-up lot, a new vehicle lot, a road shipment facility, a rail shipment facility including a section of railway on the site, and a supply chain site. Alternatively, the supply chain site can be located outside the site on the other side of the fence. The vehicle touch-up lot is the place for storing manufactured vehicles with certain defects that need to be corrected before being shipped to the sales lot. The new vehicle lot is the place for storing manufactured vehicles that are ready to be shipped to the sales lot. These vehicles that are ready to be shipped to the sales lot are waiting to be shipped to the sales points either by highway transport from the road shipment facility or by rail transport from the rail shipment facility. A test track, on which the manufactured vehicles are driven before being stored on the new vehicle lot, is also present. This track is preferably located either on the other side of the rail shipment facility, in which case a bridge or a tunnel is provided for access to it, or next to the assembly shop, on the opposite side of the wall WA shown in FIGS. 1 to 3.

The assembly shop is preferably a masonry structure. A masonry structure is a structure made of materials joined by a binder. Some nonlimiting examples of such materials are stone, brick, cinder blocks, etc. Some nonlimiting examples of such binders are mortar, plaster, cement, etc. Building the assembly shop as a “permanent” structure and not as assemblages of prefabricated elements is what gives the initial configuration its whole significance. That is, it is clearly more difficult to move a permanent building and destroy some parts thereof in order to change the layout of the assembly shop than it is to move or add prefabricated elements that are simply set up and assembled together in a movable manner.

The assembly shop is advantageously a masonry structure that advantageously comprises only one level, which will generally be the ground floor, where all work processes on the vehicle and all value-added assembly tasks, such as headlight installation, are done, i.e., generally on the ground level. However, the assembly shop can comprise one or more additional floors where some or preferably all transfer and transport processes from one portion of line to another are carried out on vehicles in production, these processes being performed at a higher level, in particular so as not to obstruct the assembly line or the traffic flows in the logistical areas inside the assembly shop. There is only one level for work on the vehicles. The terms “line” and “section” will be used indiscriminately, a line or a section being a substantially rectilinear portion of a production line and all in one piece. The assembly shop comprises exterior walls that set the boundary between the assembly shop and the outside, or interior walls setting the boundary between the assembly shop and another building separate from the assembly shop, like a built area for support functions or another workshop, e.g., for welding or painting. These walls are to be distinguished from optional partitions inside the assembly shop separating the various parts of the assembly shop from one another. A particular wall, labeled WA in FIGS. 1 to 3 and also known as a common wall, since it is the wall that is on the same side as the welding and paint shops and could even be shared between the shops, is a wall that is preferably retained in the transition from one upgrade stage to another. The wall WA faces a body trim section. Preferably, this wall WA is located comparatively toward the central part of the site on which the plant is located. It is advantageously a) parallel to a wall of the paint shop that is closest to it and b) parallel to a wall of the welding shop that is closest to it. Transitioning from one upgrade stage to another, e.g., from low to medium output or from low to high output or from medium to high output, does not preclude intermediate upgrades. An intermediate upgrade would, for example, consist in extending the lines or sections of an assembly shop for a certain time in order to move for example from a low output to a boosted low output, e.g., from 12 vehicles hour to 18 vehicles hours, before next moving to the actual medium output, e.g., 24 vehicles hour. At the boosted low output, the assembly shop has been making current production vehicles; otherwise, it is only a construction stage and not an intermediate upgrade stage. The transition from one upgrade stage to another also occurs in this case, since it is the transition from 12 vehicles hour to 24 vehicles hour: over the whole time period considered, the workshop has expanded from an output of 12 vehicles hour to an output of 24 vehicles hour. Other intermediate upgrade stages between the various production rates are possible. Preferably, such intermediate upgrade stages do not occur, as they are less profitable, or when they do, the lines or sections are extended without modifying the outer perimeter of the assembly shop, i.e., without tearing down the walls when the assembly shop is in the form of a masonry structure, so as to reduce the associated costs.

The description of FIGS. 1 to 3 will address the assembly line, the body trim part and the vehicle assembly part. The body trim part comes before the vehicle assembly part. The first step in the vehicle assembly part is typically the step of assembling and screwing down the mechanical members under the vehicle body. By way of example and illustration, an example of the workflow on an assembly line will now be described.

The workflow on an assembly line, which includes first the steps of trimming the vehicle body and then the actual vehicle assembly steps, is done simultaneously through ground-level and aerial handling. The body trim steps are carried out with ground-level handling, using a sled, for example, as a conveyance. The vehicle assembly steps are carried out with aerial handling until the vehicle is set on wheels, and uses swing trays as conveyances.

The body trim steps comprise in succession: removing the conventional doors, or where applicable, removing the sliding doors, installing soundproofing on the firewall, installing the roll bars, installing the rear deck and roof where applicable, for coupe-convertible vehicles, installing the sunroof where applicable, installing the roof trim, laying the carpet, installing the pedal bracket, installing the instrument panel, installing the gaskets, and installing the windows.

The actual vehicle assembly steps comprise in succession: assembling and screwing down the mechanical members under the vehicle body, installing the rear axle springs, testing the circuits, in particular the cooling, brake and water circuits, installing the battery in the vehicle, installing the vehicle undercarriage covers, the filling processes, particularly for the windshield washer, the fuel tank, and the aforementioned circuits, pressurizing the suspension circuit, priming the fuel system where applicable, for diesel vehicles, seating the brakes, adjusting the hand brake, mounting the main wheels, mounting the spare wheel, installing the seats, setting the vehicle on the ground, reinstalling the conventional doors, and where applicable, reinstalling the sliding side doors.

At the roll-test area, the wheels are aligned, the headlights and additional lights are adjusted, the vehicle goes through the roll-test station, and all identified defects are touched up.

FIG. 1 schematically shows an example of an assembly shop of a low-output motor vehicle manufacturing plant according to the invention. By way of indication, a low output means that fewer than 20 vehicles are manufactured per hour. This assembly shop comprises only one assembly line. It could contain one or more other assembly lines. In this case, said other assembly line(s) would preferably follow the same constraints, but not inevitably, especially if their production rate is intended not to change over time.

The arrow PF shows the production flow, which is also the direction the vehicles travel on the assembly line in the assembly shop. The body trim steps are done on the body trim line or section 1. The vehicle assembly steps are done on the vehicle assembly line or section 2. Another final vehicle assembly section 20 is located in the roll-test area 4.

Coming out of the roll-test area 4, the manufactured vehicles are routed either to the vehicle touch-up lot if they have defects, so that they can be corrected, or to the new vehicle lot if they don't have or no longer have any defects. Arriving from the supply chain site, the suppliers unload parts and subassemblies on the dock 7. The roll-test area 4 comprises a quality check area 5.

The dock 7 is preferably located on just one side of the assembly shop, and advantageously on the opposite side from the roll-test area 4 in order to avoid or at least reduce crossings and disruptions in the flow of people and vehicle traffic in the plant. The vehicles circulating in the plant are either the manufactured vehicles or the vehicles transporting raw materials, parts and subassemblies intended to supply the welding, paint, and assembly shops, and where applicable, the stamping shop.

The assembly shop also comprises secondary operations areas 3 in which certain subassemblies are assembled before coming in to supply the production flow on the assembly line. The assembly shop also comprises logistical areas 6, which are areas for storing parts or subassemblies intended for supplying either the production flow on the assembly line or the secondary operations areas 3.

The body trim section 1 faces the vehicle assembly section 2. The body trim 1 and vehicle assembly 2 sections face each other indirectly, as there is a secondary operations area 3 and a logistical area 6 between them. The sections 1 and 2 are across from one another, separated by a logistical area 6 and a secondary operations area 3. Along the vehicle assembly section 2 there is a secondary operations area 3 first, and then a logistical area 6. The roll-test area 4 is in line with the body trim 1 and vehicle assembly 2 sections.

In a preferred example with figures, the production rate is 14 vehicles per hour and the total ground area covered by the assembly shop is about 38,000 square meters, plus or minus 10%.

FIG. 2 schematically shows an example of an assembly shop of a medium-output motor vehicle manufacturing plant according to the invention. By way of indication, a medium output means that between 20 and 40 vehicles are manufactured per hour.

The vehicle assembly section in FIG. 1 has been replaced with a second body trim section 1, which faces the first body trim section 1 indirectly, with a logistical area 6 between them. The secondary operations areas 3 have been grouped together in the angular sector formed by a) the body trim sections 1 and b) the vehicle assembly sections 2. The logistical areas 6, the dock 7, and the roll-test area 4 have been expanded. Two vehicle assembly sections 2 have been added orthogonally to the body trim sections 1.

In the same preferred example with figures, the production rate has become 28 vehicles per hour and the total ground area covered by the assembly shop is now about 65,000 square meters, plus or minus 10%.

FIG. 3 schematically shows an example of an assembly shop of a high-output motor vehicle manufacturing plant according to the invention. By way of indication, a high output means that more than 40 vehicles are manufactured per hour.

The logistical area 6 located between the two body trim sections 1 in FIG. 2 has been replaced with two other body trim sections 1. The four body trim sections 1 are now aligned next to each other. They are not in line one after another as in a conventional plant; thus they are not in line with one another. The secondary operations areas 3 remain clustered in the angular sector formed by a) the body trim sections 1 and b) the vehicle assembly sections 2 and have been expanded. The logistical areas 6, the dock 7, and the roll-test area 4 have been expanded. Two additional vehicle assembly sections 2 have been added orthogonally to the body trim sections 1 and parallel to the two pre-existing vehicle assembly sections 2. The four vehicle assembly sections 2 are now aligned next to each other.

In still the same preferred example with figures, the production rate has become 55 vehicles per hour and the total ground area covered is now about 107,000 square meters, plus or minus 10%.

In order to clarify the configuration of the various parts of the assembly shop in relation to one another, a virtual T can be drawn in which the horizontal line would be made up of the roll-test area and the sections located in line with the roll-test area, whereas the vertical line of the T would be made up of the sections that are orthogonal to the above-mentioned ones. In FIGS. 2 and 3, a particular arrangement of this virtual T is shown. But it also works to arrange the T in other ways on the ground surface of the assembly shop, provided that the relative configuration of the portions of the T to one another is kept, in an identical or symmetrical form. In other words, relative to the configuration shown in FIGS. 2 and 3, configurations obtained by rotation or by axial symmetry are also workable.

More generally speaking, and aside from the precise example shown and described in FIGS. 1 to 3, or in combination with said example, various preferred options can be present by themselves or in combination with one another.

In a first embodiment of a low-output assembly shop, the assembly shop comprises at least one assembly line comprising a body trim part followed by a vehicle assembly part. The body trim part comprises a body trim section 1. The vehicle assembly part comprises a vehicle assembly section 2. Said body trim section 1 and said vehicle assembly section 2 are across from one another. The assembly shop preferably comprises a roll-test area 4 intended for testing the vehicles coming off the assembly line. The roll-test area 4 is located in line with said body trim 1 and vehicle assembly 2 sections. Preferably, the body trim part comprises only one body trim section 1 and the vehicle assembly part comprises only one vehicle assembly section 2. The vehicle production rate is preferably less than 20 vehicles per hour.

In a second embodiment of a low-output assembly shop, the assembly shop comprises at least one assembly line comprising a body trim part followed by a vehicle assembly part. The body trim part comprises two body trim sections 1 that are across from one another. The vehicle assembly part comprises two vehicle assembly sections 2 that are across from one another. Said vehicle assembly sections 2 are orthogonal to said body trim sections 1. The assembly shop preferably comprises a roll-test area 4 intended for testing the vehicles coming off the assembly line. The roll-test area 4 is located in line with said body trim sections 1. Preferably, the body trim part comprises only two body trim sections 1 and the vehicle assembly part comprises only two vehicle assembly sections 2. Preferably, the shop has been expanded on the ground level from a prior shop built some years earlier, whose vehicle production rate was lower and whose location has been retained. One of said body trim sections 1 has been retained from said prior shop. The other said body trim section 1 was installed in the location of a vehicle assembly section 2 of said prior shop. The vehicle production rate is preferably between 20 and 40 vehicles per hour.

In a third embodiment of a low-output assembly shop, the assembly shop comprises at least one assembly line comprising a body trim part followed by a vehicle assembly part. The body trim part comprises four body trim sections 1 which are aligned next to each other. The vehicle assembly part comprises four vehicle assembly sections 2 that are aligned next to each other. Said vehicle assembly sections 2 are orthogonal to said body trim sections 1. The assembly shop preferably comprises a roll-test area 4 intended for testing the vehicles coming off the assembly line. The roll-test area 4 is located in line with said body trim sections 1. Preferably, the shop has been expanded on the ground level from a prior shop built some years earlier, whose vehicle production rate was lower and whose location has been retained. Two of said body trim sections 1 have been retained from said prior shop. Two of said vehicle assembly sections 2 have been retained from said prior shop. The vehicle production rate is preferably more than 40 vehicles per hour.

In all three of the preceding embodiments, the assembly shop preferably comprises a roll-test area 4 intended for testing the vehicles coming off the assembly line, and a single supplier unloading dock 7 supplies the assembly shop. Said dock 7 is located on the opposite side of the assembly shop from the roll-test area 4. A plurality of supplier unloading docks can be provided, but this introduces more disruptions in the flow of people and vehicle traffic in the plant.

The principle of the assembly shop according to the invention is in proposing an initial or prior configuration that allows for significant upgradability with a limited level of disruption and a reasonable initial financial investment, as the ground area needed for the different proposed assembly shop sizes—preferably three—is not excessive relative to the size of the assembly shop that has the low vehicle production rate. A limited level of disruption means trying to interfere as little as possible—or not too much, at any rate—with anything relating to the production line and the masonry of the assembly shop. Limiting the level of disruption also depends on having a pattern of minimally impacting and disturbing the flow of people and vehicle traffic in the assembly shop. Although it has new features after being expanded, the upgraded plant, i.e., one that has been upgraded from an initial or prior plant, preserves the features of said initial or prior plant from which it was created.

Having the right initial configuration for the assembly shop and the right upgrade strategy in transitioning from one stage to another allows the workshop to expand while retaining at least one wall, and makes it possible at each stage to keep the secondary operations areas relatively close to the places in the assembly line where the assembled subassemblies must be supplied, to keep a supply of seats and wheels along the side of the assembly line that is synchronous, and to keep the vehicle production flow and the routing of parts and subassemblies relatively separate from one another.

An initial assembly shop is a prior assembly shop that has the following characteristic: either no other motor vehicle manufacturing plant assembly shop has existed on the site of the plant, or the existing structures of a former assembly shop are torn down before the new assembly shop is built on a site emptied of its buildings.

Preferably, for an initial assembly shop, the assembly shop was directly built on its virgin site and the vehicle production rate is less than 20 vehicles per hour. This is the case in which a low-output assembly shop is built directly on a site with no buildings, or on which the buildings were torn down beforehand.

Preferably, for an initial assembly shop, the assembly shop was directly built on its virgin site and the vehicle production rate is between 20 and 40 vehicles per hour. This is the case in which a medium-output assembly shop is built directly on a site with no buildings, or on which the buildings were torn down beforehand.

When the upgradable assembly shop is expanded, the result of the upgrade will be a bigger assembly shop that will offer some advantageous features, either for its own operation or for the possibilities that it will enable later in the next upgrade phase.

Preferably, the assembly shop has been expanded from a prior assembly shop built some years earlier and whose vehicle production rate was lower. It is actually another assembly shop originating from the expansion of an initial or prior assembly shop that was in production. Thus, these are not two construction phases for the same assembly shop, where there was no production going on between the two phases, or where there were only machine and production line tests or shakedowns between the two phases. The assembly shop has been expanded on the ground level from its previous location, which has been retained. Expanding a workshop on the ground level means increasing its area on the ground level and not increasing its area just by adding or filling in a second floor, for example.

When the location of a workshop on the ground level is retained, the new workshop, apart from being bigger than the old workshop, substantially covers the location of the old workshop; in other words, the workshop has been expanded and not replaced by a bigger workshop located elsewhere. Retaining the previous location makes it possible to keep at least part of the interior facilities of the workshop, as well as part of the interior and/or exterior masonry of the workshop, if applicable.

In order to transform an initial assembly shop into an upgraded assembly shop or an upgraded assembly shop into a further upgraded assembly shop or a final assembly shop, the invention proposes an expansion method. A final assembly shop is an assembly shop that has been upgraded in reasonable conditions, but can no longer be upgraded in reasonable conditions because it has reached the maximum growth that had been planned for it at the outset.

In the method for expanding an assembly shop of a motor vehicle manufacturing plant according to the invention in order to increase the vehicle production rate, so as to obtain a new assembly shop from a prior assembly shop some years older, wherein said prior assembly shop comprises an assembly line comprising a body trim part and a vehicle assembly part, the body trim part comprising one or more existing body trim sections, the vehicle assembly part comprising one or more existing vehicle assembly sections, firstly, multiple sections are added to said existing sections, the locations of which at least are retained, with said added sections not being placed in line with either said retained existing section(s) or with said retained locations of existing sections, and secondly, the location of the prior workshop is retained.

In a first preferred upgrade, wherein the prior workshop comprises only one body trim section and only one vehicle assembly section aligned next to each other, firstly, the existing vehicle assembly section is transformed into a body trim section, and secondly, two vehicle assembly sections are added orthogonally to the retained existing body trim section. In the first upgrade, the vehicle production rate advantageously changes from a rate less than 20 vehicles per hour to a rate between 20 and 40 vehicles per hour.

In a second preferred upgrade, wherein the prior workshop comprises only two body trim sections and two vehicle assembly sections located orthogonally to said body trim sections, firstly, two body trim sections are added in such a way that the four body trim sections of the new workshop are aligned next to each other, and secondly, two vehicle assembly sections are added in such a way that the four vehicle assembly sections of the new workshop are aligned next to each other. The two added body trim sections are advantageously added between the two existing body trim sections. At least one wall WA of the assembly shop is preferably retained. In the second upgrade, the vehicle production rate advantageously changes from a rate between 20 and 40 vehicles per hour to a rate greater than 40 vehicles per hour.

In a third preferred upgrade, the first and the second upgrades are carried out together as one. In the third upgrade, the vehicle production rate advantageously changes from a rate less than 20 vehicles per hour to a rate greater than 40 vehicles per hour.

1. Assembly shop of a motor vehicle manufacturing plant, comprising:
at least one assembly line comprising a body trim part followed by a vehicle assembly part,
wherein
the body trim part comprises a body trim section,
the vehicle assembly part comprises a vehicle assembly section,
said body trim section and said vehicle assembly section being across from one another.

2. Assembly shop according to claim 1, comprising a roll-test area intended for testing the vehicles coming off the assembly line and the roll-test area is located in line with said body trim and vehicle assembly sections.

3. Assembly shop according to claim 1, wherein the body trim part comprises only one body trim section and the vehicle assembly part comprises only one vehicle assembly section.

4. (canceled)

5. Assembly shop of a motor vehicle manufacturing plant, comprising:
at least one assembly line comprising a body trim part followed by a vehicle assembly part,
wherein
the body trim part comprises two body trim sections (1) that are across from one another,
the vehicle assembly part comprises two vehicle assembly sections (2) that are across from one another,
said vehicle assembly sections are orthogonal to said body trim sections.

6. Assembly shop according to claim 5, comprising a roll-test area intended for testing the vehicles coming off the assembly line and in that the roll-test area is located in line with said body trim sections.

7. Assembly shop according to claim 5, wherein the body trim part comprises only two body trim sections and the vehicle assembly part comprises only two vehicle assembly sections.

8. Assembly shop according to claim 5, wherein the shop has been expanded on the ground level from a prior shop built some years earlier, whose vehicle production rate was lower and whose location has been retained, one of said body trim sections has been retained from said prior workshop and the other said body trim section has been installed in the location of a vehicle assembly section of said prior shop.

9. (canceled)

10. Assembly shop of a motor vehicle manufacturing plant, comprising:
at least one assembly line comprising a body trim part followed by a vehicle assembly part,
wherein
the body trim part comprises four body trim sections that are aligned next to each other;
the vehicle assembly part comprises four vehicle assembly sections that are aligned next to each other;
said vehicle assembly sections are orthogonal to said body trim sections.

11. Assembly shop according to claim 10, comprising a roll-test area intended for testing the vehicles coming off the assembly line and in that the roll-test area is located in line with said body trim sections.

12. Assembly shop according to claim 10, wherein the shop has been expanded on the ground level from a prior shop built some years earlier, whose vehicle production rate was lower and whose location has been retained, two of said body trim sections have been retained from said prior shop, and two of said vehicle assembly sections have been retained from said prior shop.

13. (canceled)

14. Assembly shop according to claim 1, wherein the assembly shop is a masonry structure.

15. Assembly shop according to claim 1, comprising a roll-test area intended for testing the vehicles coming off the assembly line and a single supplier unloading dock supplies the assembly shop, and said dock is located on the opposite side of the assembly shop from the roll-test area.

16. Method for expanding an assembly shop of a motor vehicle manufacturing plant in order to increase the vehicle production rate, so as to obtain a new assembly shop from a prior assembly shop some years older, wherein said prior assembly shop comprises an assembly line comprising a body trim part and a vehicle assembly part, the body trim part comprises one or more existing body trim sections, and the vehicle assembly part comprises one or more existing vehicle assembly sections, said method comprising adding a plurality of sections to said existing sections, whose locations at least are retained, wherein said added sections are not placed in line with said retained existing section or sections nor with said retained location or locations of existing sections, and the location of the previous workshop is retained.

17. Method for expanding an assembly shop according to claim 16, wherein the prior workshop comprises only one body trim section and only one vehicle assembly section aligned next to each other, the existing vehicle assembly section is transformed into a body trim section, and two vehicle assembly sections are added orthogonally to the retained existing body trim section.

18. Method for expanding an assembly shop according to claim 16, wherein the prior workshop comprises only two body trim sections and two vehicle assembly sections located orthogonally to said body trim sections, two body trim sections are added in such a way that the four body trim sections of the new workshop are aligned next to each other, and two vehicle assembly sections are added in such a way that the four vehicle assembly sections of the new workshop are aligned next to each other.

19. Method for expanding an assembly shop according to claim 18, wherein the two added body trim sections are added between the two existing body trim sections.

20. Method for expanding an assembly shop according to claim 16, wherein at least one wall of the assembly shop is retained.

21-23. (canceled)
